(19) United States
(12) Patent Application Publication
(10) Pub. No.: US 2024/0092474 A1
(43) Pub. Date: Mar. 21, 2024

(54) Wing Element Structure for Aircraft, Wing Structure, and Aircraft

(71) Applicant: WESTLAKE UNIVERSITY, Hangzhou, Zhejiang (CN)

(72) Inventors: Bing LUO, Hangzhou, Zhejiang (CN); Wei LI, Hangzhou, Zhejiang (CN); Weicheng CUI, Hangzhou, Zhejiang (CN)

(21) Appl. No.: 18/038,220

(22) PCT Filed: Nov. 23, 2020
(86) PCT No.: PCT/CN2020/130836

§ 371 Date: May 23, 2023

(51) Int. Cl. B64C 3/48

(52) U.S. Cl. CPC B64C 3/48

(57) ABSTRACT

Embodiments of the present disclosure provide a wing element structure for an aircraft, comprising a plurality of wing element units, wherein adjacent wing element units are connected by airfoil control units, hydraulic units and wing element outer edge connecting members, each of the wing element units comprises a plurality of wing element edge members connected to one another and a wing support rod connecting member, and the wing support rod connecting member located in a wing leading edge in the wing element unit is connected to a support rod structure on an aircraft main body. The embodiments of the present disclosure provide a wing element structure having a wide range of morphing airfoil features in terms of chord length and curvature; the embodiments of present disclosure have the capability of morphing airfoil and variable pitch angle in a wide range, and can make adjustment regarding complex flow fields or environments, which greatly improves the movement speed and movement efficiency and can achieve high-mobility actions.

### TECHNICAL FIELD

The present disclosure relates to the field of navigation devices, and in particular, to a wing element structure for an aircraft, a wing structure and an aircraft.

### BACKGROUND

Aircrafts existing in the related art mostly adopt a fixed-wing structure or a relatively limited morphing wing structure; in this way, adjustment cannot be made regarding actual navigation or flight environments or complex flow fields, causing poor navigation or flight efficiency and poor stability, and being incapable of achieving high-mobility actions.

### SUMMARY

An object of embodiments of the present disclosure is to provide a wing element structure for an aircraft, wing structure and an aircraft, so as to solve the problems in the related art of being incapable of making adjustment regarding actual navigation or flight environments or complex flow fields, poor navigation or flight efficiency and poor stability, and being incapable of achieving high-mobility actions.

In order to solve the technical problems, embodiments of the present disclosure adopt the following technical solutions: a wing element structure for an aircraft, comprising a plurality of wing element units, wherein adjacent wing element units are connected by airfoil control units, hydraulic units and wing element outer edge connecting members, each of the wing element units comprises a plurality of wing element edge members connected to one another and a wing support rod connecting member, and the wing support rod connecting member located in a wing leading edge in the wing element unit is connected to a support rod structure on an aircraft main body.

In some embodiments, the wing element unit further comprises wing connecting members, and the wing support rod connecting member connected to the support rod structure is connected to the wing connecting members by the hydraulic units, or a plurality of the wing connecting members are connected by the hydraulic units.

In some embodiments, the plurality of wing element units comprise a wing element leading edge unit and a wing element trailing edge unit, and at least one wing element middle unit is provided between the wing element leading edge unit and the wing element trailing edge unit.

In some embodiments, the wing support rod connecting member in the wing element leading edge unit is connected to the support rod structure, the wing support rod connecting member in the wing element leading edge unit is connected to a wing connecting member in the wing element middle unit by a first hydraulic unit, and the connecting member in the wing element middle unit is connected to a wing connecting member in the wing element trailing edge unit by a second hydraulic unit.

In some embodiments, the wing support rod connecting member in the wing element leading edge unit is connected to the support rod structure, the wing support rod connecting member in the wing element leading edge unit is connected to the wing connecting member in the wing element middle unit by a third hydraulic unit, and the wing support rod connecting member in the wing element leading edge unit is connected to the wing connecting member in the wing element trailing edge unit by a fourth hydraulic unit.

In some embodiments, the wing element leading edge unit comprises a wing element leading edge arc-shaped member, a first wing element edge member, an eighth wing element edge member, and a wing leading edge support rod connecting member; a first end of the first wing element edge member and a first end of the eighth wing element edge member are respectively connected to a first end and a second end of the wing element leading edge arc-shaped member; a second end of the first wing element edge element and a second end of the eighth wing element edge member are respectively connected to a first rolling bearing and a sixth rolling bearing; the first rolling bearing and the sixth rolling bearing are connected by a first wing element unit support member, and the first wing element unit support member passes through and is connected to the wing leading edge support rod connecting member.

In some embodiments, the wing element trailing edge unit comprises a wing element trailing edge wedge-shaped member, a fourth wing element edge member, a fifth wing element edge member and a wing trailing edge wing element support connecting member; a first end of the fourth wing element edge member and a first end of the fifth wing element edge member are respectively connected to a first end and a second end of the wing element trailing edge wedge-shaped member; a second end of the fourth wing element edge member and a second end of the fifth wing element edge member are respectively connected to a third rolling bearing and a fourth rolling bearing; the third rolling bearing and the fourth rolling bearing are connected by a third wing element unit support member, and the third wing element unit support member passes through and is connected to the wing trailing edge wing element support connecting member.

In some embodiments, the wing element middle unit comprises a second wing element edge member, a third wing element edge member, a sixth wing element edge member, a seventh wing element edge member, and a wing middle wing element support connecting member; a first end of the second wing element edge member and a first end of the third wing element edge member are connected by a second rolling bearing, and a first end of the sixth wing element edge member and a first end of the seventh wing element edge member are connected by a fifth rolling bearing; the second rolling bearing and the fifth rolling bearing are connected by a second wing element unit support member, and the second wing element unit support member passes through and is connected to the wing middle wing element support connecting member.

In some embodiments, the wing element edge members of adjacent wing element units are connected by the wing element outer edge connecting members, each wing element outer edge connecting member comprise a flexible connecting member and a sliding cover plate; the flexible connecting member can telescopically connect adjacent wing element edge members, one end of the sliding cover plate is fixedly connected to an end of one wing element edge member, and the other end of the sliding cover plate is slidably connected to an end of the other adjacent wing element edge member.

In some embodiments, each of the airfoil control units comprises a sliding ring connecting rod, a sliding ring and a sliding rod, wherein one end of the sliding ring connecting rod is connected to a side surface of the wing support rod connecting member or wing connecting member of a first wing unit of a first wing element unit, and the other end of the sliding ring connecting rod is connected to the sliding ring; the sliding rod is provided on a side surface of the wing connecting member of a second wing element unit adjacent to the first wing element unit and extends towards the direction of the wing support rod connecting member or wing connecting member of the first wing unit, and the sliding ring is sleeved on the sliding rod and can slide along the sliding rod in a reciprocating manner.

In some embodiments, a sliding rod base is provided at the top of the sliding rod, two sliding rod base hinged supports are respectively provided on a first side and a second side, opposite each other, of the sliding rod base, and each sliding rod base hinged support is connected to a corresponding sliding ring hinged support on the sliding ring by a lever group.

In some embodiments, on a first side or a second side of the sliding rod base, the lever group comprises a front rod and a rear rod connected to each other, a first end of the front rod is connected to a corresponding sliding rod base hinged support, a second end of the front rod is connected to a corresponding wing element edge member by a hinged support, a middle part of the front rod is connected to a first end of the rear rod by another hinged support, and a second end of the rear rod is connected to a corresponding sliding ring hinged support on the sliding ring.

Embodiments of the present disclosure further provide a wing structure, comprising the wing element structure described in any one of the technical solutions above.

Embodiments of the present disclosure further provide an aircraft, using the wing structure described in any one of the technical solutions above.

The embodiments of the present disclosure have the feature of a wide-range morphing wing; the wing structure has the capability of morphing airfoil and variable pitch angle in a wide range, and can make adjustment regarding complex flow fields or environments, which greatly improves the movement speed and movement efficiency and can achieve high-mobility actions.

### BRIEF DESCRIPTION OF THE DRAWINGS

In order to describe the technical solutions in the embodiments of the present disclosure or in the related art more clearly, hereinafter, accompanying drawings requiring to be used for describing the embodiments or the related art are introduced briefly. Apparently, the accompanying drawings in the following description merely relate to some embodiments disclosed in the present disclosure, and for a person of ordinary skill in the art, other accompanying drawings can also be obtained according to these accompanying drawings without involving any inventive effort.

FIG. 1 is a schematic diagram of mounting of a wing element structure provided in a first embodiment of the present disclosure;

FIG. 2 is a sectional view of the wing element structure provided in the first embodiment of the present disclosure;

FIG. 3 is a schematic diagram of a three-dimensional structure of the wing element structure provided in the first embodiment of the present disclosure;

FIG. 4 is a schematic connection diagram of the wing element structure provided in the first embodiment of the present disclosure;

FIG. 5 is a schematic structural diagram of an airfoil control unit in the wing element structure according to the first embodiment of the present disclosure;

FIG. 6 is a schematic structural diagram of the airfoil control unit in the wing element structure according to the first embodiment of the present disclosure;

FIG. 7 is a schematic structural diagram of the airfoil control unit in the wing element structure according to the first embodiment of the present disclosure;

FIG. 8 is a schematic connection diagram of the airfoil control unit in the wing element structure according to the first embodiment of the present disclosure;

FIG. 9 is a schematic structural diagram of the airfoil control unit in the wing element structure according to the first embodiment of the present disclosure;

FIG. 10 is a schematic structural diagram of a hydraulic unit in the wing element structure according to the first embodiment of the present disclosure;

FIG. 11 is a schematic diagram of a posture change of the wing element structure according to the first embodiment of the present disclosure;

FIG. 12 is a schematic diagram of a posture change of the wing element structure according to the first embodiment of the present disclosure;

FIG. 13 is a schematic diagram of a posture change of the wing element structure according to the first embodiment of the present disclosure;

FIG. 14 is a schematic diagram of a posture change of the wing element structure according to the first embodiment of the present disclosure;

FIG. 15 is a schematic diagram of a posture change of the wing element structure according to the first embodiment of the present disclosure;

FIG. 16 is a schematic diagram of a posture change of the wing element structure according to the first embodiment of the present disclosure;

FIG. 17 is a schematic diagram of a three-dimensional structure of a wing element structure provided in a second embodiment of the present disclosure;

FIG. 18 is a schematic structural diagram of a hydraulic unit in the wing element structure according to the second embodiment of the present disclosure;

FIG. 19 is a schematic structural diagram of the hydraulic unit in the wing element structure according to the second embodiment of the present disclosure;

FIG. 20 is a schematic diagram of a posture change of the wing element structure according to the second embodiment of the present disclosure;

FIG. 21 is a schematic diagram of a posture change of the wing element structure according to the Second embodiment of the present disclosure;

FIG. 22 is a schematic diagram of a posture change of the wing element structure according to the second embodiment of the present disclosure;

FIG. 23 is a schematic diagram of a posture change of the wing element structure according to the second embodiment of the present disclosure;

FIG. 24 is a schematic diagram of a posture change of the wing element structure according to the second embodiment of the present disclosure; and

FIG. 25 is a schematic diagram of a posture change of the wing element structure according to the second embodiment of the present disclosure.

### REFERENCE SIGNS

a—Wing leading edge support rod structure; d—Aircraft main body; 100—Wing leading edge support rod; 400—Wing element outer frame; 110—Wing leading edge support rod connecting member; 210—Wing middle wing element support connecting member; 310—Wing trailing edge wing element support connecting member; 500—First airfoil control unit; 600—Second airfoil control unit; 1—Wing element leading edge arc-shaped member; 2—First wing element edge member; 3—First wing element outer edge connecting member; 4—Second wing element edge member; 5—Third wing element edge member; 6—Second wing element outer edge connecting member; 7—Fourth wing element edge member; 8—Wing element trailing edge wedge-shaped member; 9—Fifth wing element edge member; 10—Third wing element outer edge connecting member; 11—Sixth wing element edge member; 12—Seventh wing element edge member; 13—Fourth wing element outer edge connecting member; 14—Eighth wing element edge member; 15—First wing element support rod; 16—Second wing element support rod; 17—Third wing element support rod; 18—Fourth wing element support rod; 19—Fifth wing element support rod; 20—Sixth wing element support rod; 21—First connecting shaft sleeve; 22—Second connecting shaft sleeve; 23—First sliding ring connecting rod; 24—First sliding ring; 25—First sliding rod; 26—First spherical hinged support; 27—First hinged support; 28—First straight rod; 29—First U-shaped rod; 30—First sliding rod base; 31—First sliding rod base hinged support; 32—Second sliding rod base hinged support; 33—Third sliding rod base hinged support; 34—Fourth sliding rod base hinged support; 35—First lever group; 36—Second lever group; 37—Third lever group; 38—Fourth lever group; 39—First sliding ring hinged support; 40—Second sliding ring hinged support; 41—Third sliding ring hinged support; 42—Fourth sliding ring hinged support; 43—First rod; 44—Second rod; 45—First hinged support; 46—Second hinged support; 47—Third rod; 48—Fourth rod; 49—Third hinged support; 50—Fourth hinged support; 51—Fifth rod; 52—Sixth rod; 53—Fifth hinged support; 54—Sixth hinged support; 55—Seventh rod; 56—Eighth rod; 57—Seventh hinged support; 58—Eighth hinged support; 59—Second spherical hinged support; 60—Third spherical hinged support; 61—Second hinged support; 62—Third hinged support; 63—First hydraulic cylinder; 64—First hydraulic push rod; 65—Second hydraulic cylinder; 66—Second hydraulic push rod; 67—First rotating motor; 68—Second rotating motor; 69—Fourth hinged support; 70—Fifth hinged support; 71—Third hydraulic cylinder; 72—Third hydraulic push rod; 73—Fourth hydraulic cylinder; 74—Fourth hydraulic push rod.

### DETAILED DESCRIPTION OF THE EMBODIMENTS

Various solutions and features of the present disclosure are described herein with reference to the accompanying drawings.

It will be appreciated that various modifications can be made to the embodiments as applied herein. Accordingly, the description should not be construed as limiting but merely as exemplifications of the embodiments. A person skilled in the art would have conceived of other modifications within the scope and spirit of the present disclosure.

The accompanying drawings, which are incorporated in the description and constitute a part of the description, illustrate embodiments of the present disclosure, and together with a general description of the present disclosure given above and the detailed description of the embodiments given below, serve to explain the principle of the present disclosure.

These and other features of the present disclosure will become apparent from the following description of preferred forms of embodiment given as non-limiting examples with reference to the accompanying drawings.

It should also be understood that while the present disclosure has been described with reference to specific examples, a person skilled in the art would be able to conclusively implement many other equivalent forms of the present disclosure having the features of the claims and thus all being within the scope of protection defined thereby.

The above and other aspects, features, and advantages of the present disclosure will become more apparent in view of the following detailed description when taken in conjunction with the accompanying drawings.

Hereinafter, specific embodiments of the present disclosure are described with reference to the accompanying drawings. However, it should be understood that the embodiments as applied are merely examples of the present disclosure, which may be implemented in various ways. Well-known and/or duplicate functions and structures have not been described in detail to avoid unnecessary or redundant details which obscure the present disclosure. Therefore, specific structural and functional details as applied herein are not intended for limiting, but merely as a basis and a representative basis for the claims and for teaching a person skilled in the art to diversely use the present disclosure in substantially any suitable detailed structure.

The description may use phrases “in one embodiment”, “in another embodiment”, “in yet another embodiment”, or “in other embodiments”, which may each refer to one or more of the same or different embodiments according to the present disclosure.

Embodiments of the present disclosure provide a wing element structure for an aircraft, a wing structure and an aircraft.

The wing structure herein is composed of the wing element structure, and the wing structure is mounted on the aircraft; the aircraft herein can achieve navigation or flying, taxiing and other high-mobility actions on the basis of movement of the wing structure such as swinging, etc. in the air or water; and the structure of the aircraft herein may be a bionic structure such as a bionic bird, a bionic fish or the like, and may also be a structure such as an airplane-type dual-wing aircraft, and the specific structure of the aircraft is not limited in the present disclosure.

The wing structure herein is arranged at any position on the main body of the aircraft, for example, may be arranged on a side surface of the main body of the aircraft, may be arranged on a single side surface, and may also be arranged on two symmetrical side surfaces of the main body of the aircraft; and herein, the arrangement position of the wing structure is also not limited in the present disclosure.

In the wing structure involved in the embodiments of the present disclosure, a plurality of wing element structures in the embodiments of the present disclosure can be connected by an independent support rod structure, so as to achieve movement of the wing structure. Each wing element structure comprises wing element units and airfoil control structures; and according to the number of the wing element units and the number of the airfoil control structures used in the wing structure, different forms of wing structures can be realized, thereby realizing different motion postures and motion degrees.

Specifically, the wing structure involved in the embodiments of the present disclosure comprises one support rod structure; the support rod structure extends from the main body of the aircraft toward a wingtip direction, and the wing element structures involved in the embodiments of the present disclosure are provided on the support rod structure. In the following embodiments of the present disclosure, description of technical solutions is made by taking the wing structure comprising one support rod structure as an example.

As shown in FIG. 1, in the wing structure involved in the embodiment of the present disclosure, the support rod structure, i.e. a wing leading edge support rod structure a, is provided at a wing leading edge portion, and the wing leading edge support rod structure a is rotatably connected to a side surface of the aircraft main body d.

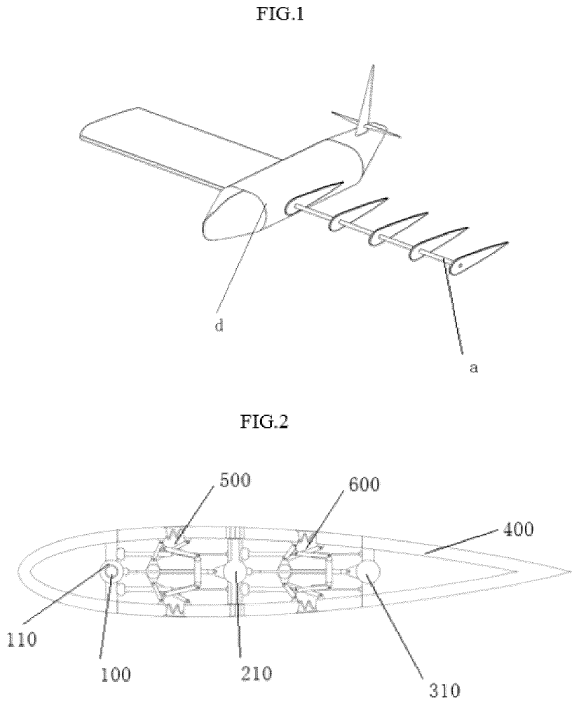

A first embodiment of the present disclosure provides a wing element structure capable of being deformed in multiple dimensions. A plurality of the wing element structures are sequentially sleeved on the wing leading edge support rod structure a to form the wing structure. As shown in FIGS. 1 and 2, the wing structure comprises a wing leading edge support rod 100 provided on a side surface of the aircraft main body d, and one end of the wing leading edge support rod 100 is rotatably connected to the side surface of the aircraft main body d. Here, the extension direction of the wing leading edge support rod 100 is defined as a first direction, and the plurality of wing element structures are sequentially sleeved on the wing leading edge support rod 100. The movement of the wing leading edge support rod 100 under driving of a driving device (e.g. a motor) can drive the movement of the wing element structures, thereby driving the movement of the whole wing structure.

Each of the wing element structures provided in the first embodiment of the present disclosure comprises a plurality of wing element units; adjacent wing element units are connected by means of the airfoil control structures and wing element outer edge connecting members, and each wing element unit comprises at least one wing element edge member and a wing support rod connecting member. As shown in FIGS. 1 and 2, the wing element structure is connected to the support rod structure on the aircraft main body d by means of a wing support rod connecting member in one wing element unit. The support rod structure herein is the wing leading edge support rod 100, and the wing element edge members and the wing element outer edge connecting members constitute a wing element outer frame 400 of the wing element structure.

In the embodiments of the present disclosure, the wing element structure comprises a wing element leading edge unit and a wing element trailing edge unit, and at least one wing element middle unit is provided between the wing element leading edge unit and the wing element trailing edge unit; wherein the number of the wing element middle unit may be one, and may also be plural, the number of the wing element middle unit is determined according to the overall length of the wing element structure, and in the embodiments of the present disclosure, the number of the wing element middle unit is one.

In the embodiments of the present disclosure, as shown in FIGS. 1 and 2, the wing element structure is connected to the aircraft main body d by the connection between the wing element leading edge unit and the wing leading edge support rod 100. The wing element leading edge unit is connected to the wing element middle unit by a first airfoil control unit 500, and the wing element middle unit is connected to the wing element trailing edge unit by a second airfoil control unit 600.

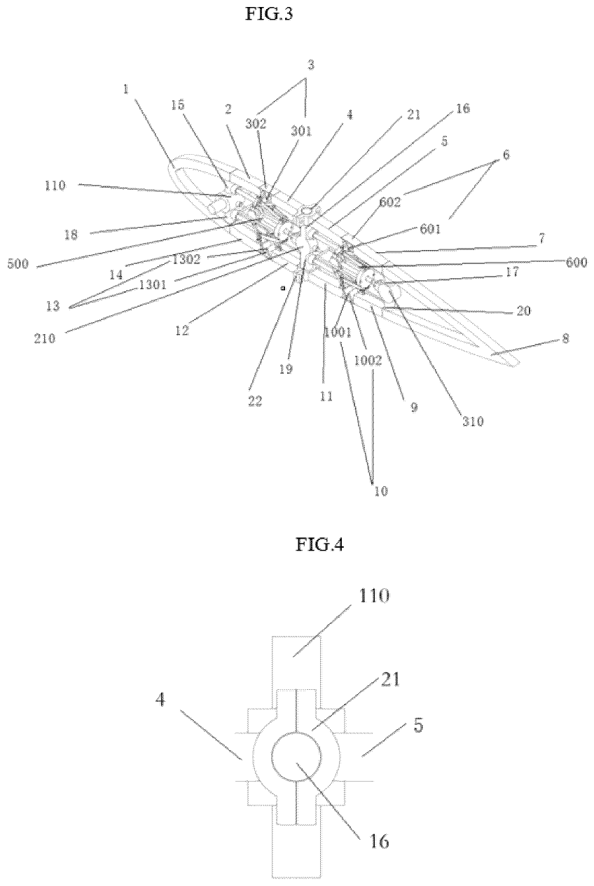

Specifically, referring to FIG. 3 and in conjunction with FIG. 2, FIG. 3 shows a schematic structural diagram of the wing element structure; the wing element leading edge unit is located at a leading edge position of the wing element structure, and comprises a wing element leading edge arc-shaped member 1, a first wing element edge member 2, an eighth wing element edge member 14, and a vying leading edge support rod connecting member 110; the wing leading edge support rod connecting member 110 is connected to the wing leading edge support rod 100; wherein the first wing element edge member 2 and the eighth wing element edge member 14 are respectively located at an upper side and a lower side of the wing element leading edge unit; an end face of a first end of the first wing element edge member 2 and an end face of a first end of the eighth wing element edge member 14 are respectively connected to a first end and a second end of the wing element leading edge arc-shaped member 1, wherein each wing element edge member can achieve passive deformation. The first end and the second end of the wing element leading edge arc-shaped member 1 are connected to the wing leading edge support rod connecting member 110 by a first wing element support rod 15 and a fourth wing element support rod 18, and the wing element structure is connected to the wing leading edge support rod 100 by the wing leading edge support rod connecting member 110.

The wing element middle unit is located at a middle position of the wing element structure, and comprises a second wing element edge member 4, a third wing element edge member 5, a sixth wing element edge member 11, a seventh wing element edge member 12 and a wing middle wing element support connecting member 210; wherein the second wing element edge member 4 and the third wing element edge member 5 are located at an upper side of the wing element middle unit, and the sixth wing element edge member 11 and the seventh wing element edge member 12 are located at a lower side of the wing element middle unit, and each wing element edge member herein can achieve passive deformation. In conjunction with FIG. 4, a first end of the second wing element edge member 4 is connected to a first end of the third wing element edge member 5 by a first connecting shaft sleeve 21, and a first end of the sixth wing element edge member 11 is connected to a first end of the seventh wing element edge member 12 by a second connecting shaft sleeve 22; the first connecting shaft sleeve 21 is connected to the wing middle wing element support connecting member 210 by a second wing element support rod 16, and the second connecting shaft sleeve 22 is connected to the wing middle wing element support connecting member 210 by a fifth wing element support rod 19.

The wing element trailing edge unit is located at a trailing edge position of the wing element structure, and comprises a wing element trailing edge wedge-shaped member 8, a fourth wing element edge member 7, a fifth wing element edge member 9 and a wing trailing edge wing element support connecting member 310; wherein the fourth wing element edge member 7 and the fifth wing element edge member 9 are respectively located at an upper side and a lower side of the wing element trailing edge unit; and an end face of a first end of the fourth wing element edge member 7 and an end face of a first end of the fifth wing element edge member 9 are respectively connected to a first end and a second end of the wing element trailing edge wedge-shaped member 8, and each wing element edge member herein can achieve passive deformation. The first end and the second end of the wing element trailing edge wedge-shaped member 8 are connected to the wing trailing edge wing element support connecting member 310 by a third wing element support rod 17 and a sixth wing element support rod 20.

The first connecting shaft sleeve 21 and the second connecting shaft sleeve 22 are fixedly connected to all the second wing element edge member 4, the third wing element edge member 5, the sixth wing element edge member 11 and the seventh wing element edge member 12 which can achieve passive deformation. As each connecting shaft sleeve achieves fixed connection by bolts to form a shaft sleeve, the first connecting shaft sleeve 21 and the second connecting shaft sleeve 22 can slide on the second wing element support rod 16 and the fifth wing element support rod 19 respectively; the first wing element support rod 15 and the fourth wing element support rod 18 are fixedly connected to the wing leading edge support rod connecting member 110, the second wing element support rod 16 is fixedly connected to the fifth wing element support rod 19, and the third wing element support rod 17 is fixedly connected to the sixth wing element support rod 20; wherein the second wing element support rod 16 and the fifth wing element support rod 19 have limiting devices for the first connecting shaft sleeve 21 and the second connecting shaft sleeve 22, so that the first and second connecting shaft sleeves have the capability of bearing pressure.

As stated above, adjacent wing element units are connected by the airfoil control units. Specifically, in order to achieve motion connection between the wing element leading edge unit, the wing element middle unit and the wing element trailing edge unit, specifically, the wing leading edge support rod connecting member 110, the wing middle wing element support connecting member 210 and the wing trailing edge wing element support connecting member 310 are connected by the airfoil control units. Specifically, the wing leading edge support rod connecting member 110 is connected to the wing middle wing element support connecting member 210 by the first airfoil control unit 500, and the wing middle wing element support connecting member 210 is connected to the wing trailing edge wing element support connecting member 310 by the second airfoil control unit 600. Considering that the movement of the wing leading edge support rod 100 under driving of a driving device (e.g. a motor) can drive the movement of the whole wing element structure, the wing leading edge support rod connecting member 110 may be, for example, a rotor of a motor, and may also be a shaft sleeve, so that active driving movement or passive movement can be achieved. The specific selection is determined on the basis of factors such as the requirements of the aircraft and positions, which is not limited in the present disclosure.

Further, as stated above, adjacent wing element units are connected by wing element outer edge connecting members. Specifically, wing element edge members of adjacent wing element units are connected by the wing element outer edge connecting members. In the embodiments of the present disclosure, the upper and lower sides of the wing element leading edge unit and the wing element middle unit are connected by a first wing element outer edge connecting member 3 and a fourth wing element outer edge connecting member 13 respectively; and the upper and lower sides of the wing element middle unit and the wing element trailing edge unit are connected by a second wing element outer edge connecting member 6 and a third wing element outer edge connecting member 10 respectively. On one side of the wing element structure, the first wing element outer edge connecting member 3 comprises a first flexible connecting member 301 and a first sliding cover plate 302 which are telescopic, wherein the first flexible connecting member 301 and the first sliding cover plate 302 are arranged between an end face of the first wing element edge member 2 of the wing element leading edge unit and an end face of the second wing element edge member 4 of the wing element middle unit; and the second wing element outer edge connecting member 6 comprises a second flexible connecting member 601 and a second sliding cover plate 602 which are telescopic, wherein the second flexible connecting member 601 and the second sliding cover plate 602 are arranged between an end face of the third wing element edge member 5 of the wing element middle unit and an end face of the fourth wing element edge member 7. On the other side of the wing element structure, the third wing element outer edge connecting member 10 comprises a third flexible connecting member 1001 and a third sliding cover plate 1002 which are telescopic, wherein the third flexible connecting member 1001 and the third sliding cover plate 1002 are arranged between an end face of the fifth wing element edge member 9 of the wing element trailing edge unit and an end face of the sixth wing element edge member 11 of the wing element middle unit; and the fourth wing element outer edge connecting member 13 comprises a fourth flexible connecting member 1301 and a fourth sliding cover plate 1302 which are telescopic, wherein the fourth flexible connecting member 1301 and the fourth sliding cover plate 1302 are arranged between an end face of the seventh wing element edge member 12 of the wing element middle unit and an end face of the eighth wing element edge member 14 of the wing element leading edge unit.

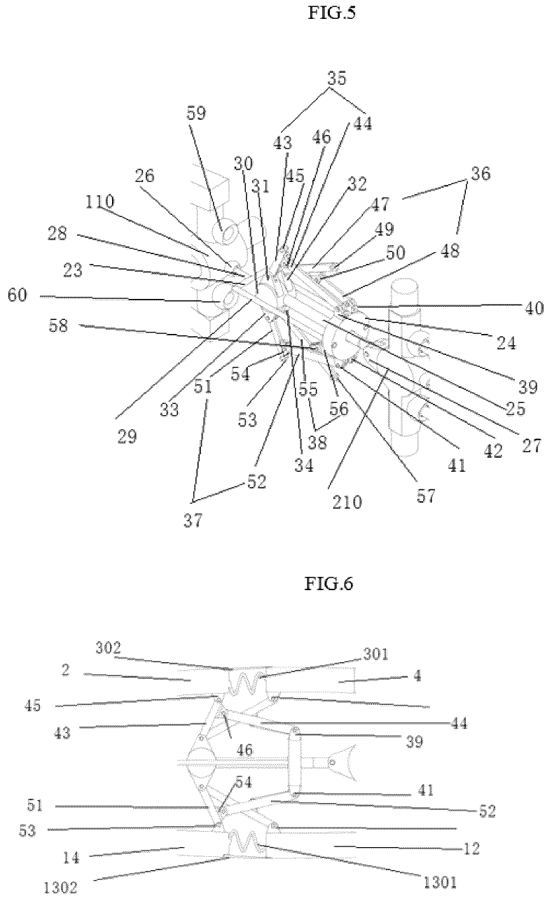

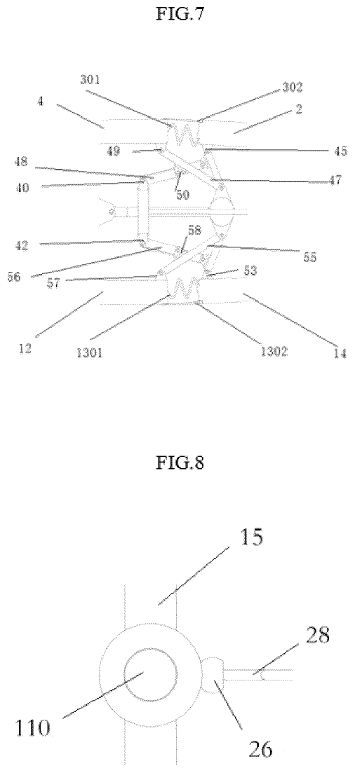

As stated above, the wing element leading edge unit is connected to the wing element middle unit by the first airfoil control unit 500. Specifically, the wing leading edge support rod connecting member 110 is connected to the wing middle wing element support connecting member 210 by the first airfoil control unit 500. As shown in FIGS. 5-7, in which FIG. 5 shows a three-dimensional structure of the first airfoil control unit 500 and a connection relationship between same and the wing leading edge support rod connecting member 110 and the wing middle wing element support connecting member 210; and FIGS. 6 and 7 further show the structure of the first airfoil control unit 500 and a connection relationship between same and the wing leading edge support rod connecting member 110 and the wing middle wing element support connecting member 210 from two side surfaces respectively.

The first airfoil control unit 500 comprises a first sliding ring connecting rod 23, a first sliding ring 24 and a first sliding rod 25; wherein one end of the first sliding ring connecting rod 23 is connected to the side surface of the wing leading edge support rod connecting member 110 facing the wing middle wing element support connecting member 210, and the other end of the first sliding ring connecting rod 23 is connected to the first sliding ring 24; the first sliding rod 25 is provided on the side surface of the wing middle wing element support connecting member 210 facing the wing leading edge support rod connecting member 110; and the first sliding ring 24 is sleeved on the first sliding rod 25 and can slide along the first sliding rod 25 in a reciprocating manner. Specifically, as shown in FIG. 8, a first spherical hinged support 26 is provided on the side surface of the wing leading edge support rod connecting member 110 facing the wing middle wing element support connecting member 210, and a first hinged support 27 is provided on the side surface of the wing middle wing element support connecting member 210 facing the wing leading edge support rod connecting member 110; wherein the first sliding ring connecting rod 23 is hinged to the first spherical hinged support 26, and the first sliding rod 25 is hinged to the first hinged support 27, and the first hinged support 27 is a fixed hinged support.

Further, the first sliding ring connecting rod 23 comprises a first straight rod 28 and a first U-shaped rod 29; one end of the first straight rod 28 is connected to the first spherical hinged support 26 on the side surface of the wing leading edge support rod connecting member 110, and the other end of the first straight rod 28 is connected to a bottom edge of the first U-shaped rod 29; and two long edges of the first U-shaped rod 29 are respectively connected to the first sliding ring 24, and the first sliding rod 25 passes through the middle of the first sliding ring 24 and is located in the middle of the two long edges.

Further, a first sliding rod base 30 is provided at the top of the first sliding rod 25, the first sliding rod base 30 is limited within an annular region enclosed by the first U-shaped rod 29 and the first sliding ring 24; a first sliding rod base hinged support 31 and a second sliding rod base hinged support 32 are provided side by side on an upper side of the first sliding rod base 30; and correspondingly, a third sliding rod base hinged support 33 and a fourth sliding rod base hinged support 34 are provided side by side on a lower side of the first sliding rod base 30; wherein the first sliding rod base hinged support 31 is connected to one end of a first lever group 35, and the other end of the first lever group 35 is connected to the first sliding ring 24; the second sliding rod base hinged support 32 is connected to one end of a second lever group 36, and the other end of the second lever group 36 is connected to the first sliding ring 24; the third sliding rod base hinged support 33 is connected to one end of a third lever group 37, and the other end of the third lever group 37 is connected to the first sliding ring 24; and the fourth sliding rod base hinged support 34 is connected to one end of a fourth lever group 38, and the other end of the fourth lever group 38 is connected to the first sliding ring 24. In this way, the first sliding rod base 30 is rotatably connected to the first sliding ring 24 by the four lever groups.

Further, a first sliding ring hinged support 39 and a second sliding ring hinged support 40 are provided at an end located at a first side of the first sliding ring 24, the other end of the first lever group 35 is rotatably connected to the first sliding ring hinged support 39 of the first sliding ring 24, and the other end of the second lever group 36 is rotatably connected to the second sliding ring hinged support 40 of the first sliding ring 24; and a third sliding ring hinged support 41 and a fourth sliding ring hinged support 42 are provided at an end located at a second side of the first sliding ring 24, the other end of the third lever group 37 is rotatably connected to the third sliding ring hinged support 41 of the first sliding ring 24, and the other end of the fourth lever group 38 is rotatably connected to the fourth sliding ring hinged support 42 of the first sliding ring 24.

Specifically, the first lever group 35 comprises a first rod 43 and a second rod 44, wherein a first end of the first rod 43 is rotatably connected to the first sliding rod base hinged support 31, and a first hinged support 45 and a second hinged support 46 are respectively provided at a second end and the middle of the first rod 43; wherein the second end of the first rod 43 is connected to the first wing element edge member 2 by the first hinged support 45, a first end of the second rod 44 is connected to the first rod 43 by the second hinged support 46, and a second end of the second rod 44 is rotatably connected to the first sliding ring hinged support 39.

The second lever group 36 comprises a third rod 47 and a fourth rod 48, a first end of the third rod 47 is rotatably connected to the second sliding rod base hinged support 32, and a third hinged support 49 and a fourth hinged support 50 are respectively provided at a second end and the middle of the third rod 47; wherein the second end of the third rod 47 is connected to the second wing element edge member 4 by the third hinged support 49, a first end of the fourth rod 48 is connected to the third rod 47 by the fourth hinged support 50, and a second end of the fourth rod 48 is rotatably connected to the second sliding ring hinged support 40.

The third lever group 37 comprises a fifth rod 51 and a sixth rod 52, a first end of the fifth rod 51 is rotatably connected to the third sliding rod base hinged support 33, and a fifth hinged support 53 and a sixth hinged support 54 are respectively provided at a second end and the middle of the fifth rod 51; wherein the second end of the fifth rod 51 is connected to the eighth wing element edge member 14 by the fifth hinged support 53, a first end of the sixth rod 52 is connected to the fifth rod 51 by the sixth hinged support 54, and a second end of the sixth rod 52 is rotatably connected to the third sliding ring hinged support 41.

The fourth lever group 38 comprises a seventh rod 55 and an eighth rod 56, a first end of the seventh rod 55 is rotatably connected to the fourth sliding rod base hinged support 34, and a seventh hinged support 57 and an eighth hinged support 58 are respectively provided at a second end and the middle of the seventh rod 55; wherein the second end of the seventh rod 55 is connected to the seventh wing element edge member 12 by the seventh hinged support 57, a first end of the eighth rod 56 is connected to the seventh rod 55 by the eighth hinged support 58, and a second end of the eighth rod 56 is rotatably connected to the fourth sliding ring hinged support 42.

In this way, each lever group forms a rotatable connection with the wing element edge member on the wing element outer frame 400 by the hinged support, thereby realizing a linkage relationship between the airfoil control structure and the wing element outer frame 400.

In order to enable the first airfoil control unit 500 at the front of the wing element to still realize airfoil control capability under complex deformation of the first wing element edge member 2, the second wing element edge member 4, the seventh wing element edge member 12 and the eighth wing element edge member 14, and to transmit the relative movement between the first sliding ring 24 and the first sliding rod 25, as shown in FIG. 8, the first sliding ring connecting rod 23 is connected to the wing leading edge support rod connecting member 110 by the first spherical hinged support 26 in a spherical hinge manner; however, the first sliding rod 25 is connected to the wing middle wing element support connecting member 210 by the first hinged support 27 in a fixed hinge manner.

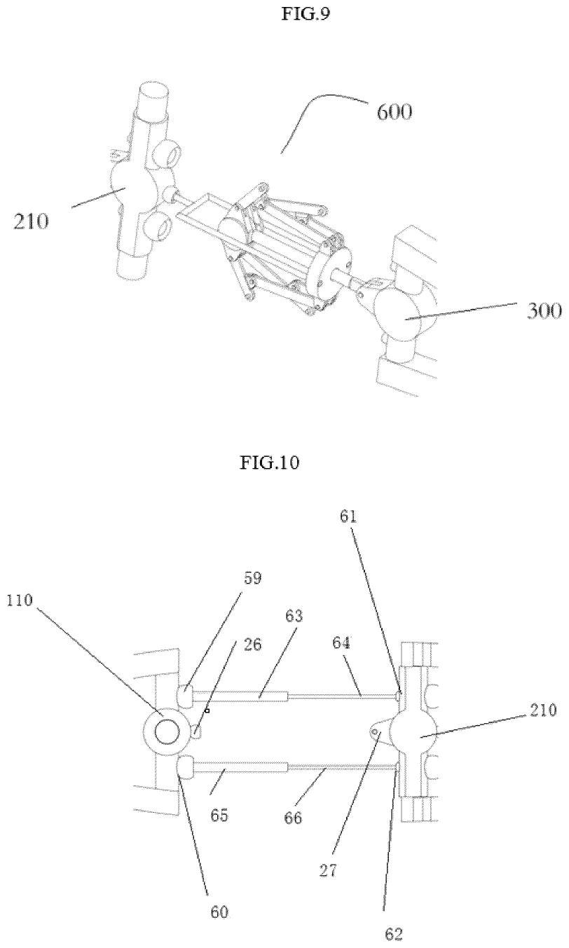

As described above, the wing middle wing element support connecting member 210 is connected to the wind trailing edge wing element support connecting member 310 by the second airfoil control unit 600. As shown in FIG. 9, FIG. 9 shows a three-dimensional structure of the second airfoil control unit 600 and a connection relationship between same and the wing middle wing element support connecting member 210 and the wing trailing edge wing element support connecting member 310. The structure of the second airfoil control unit 600 is the same as that of the first airfoil control unit 500, and will not be elaborated more in the present disclosure.

Further, as shown in FIG. 10, considering that the aircraft main body d is connected to the wing element structures only by the wing leading edge support rod 100, and the movement of the wing leading edge member needs to be transferred to the wing middle part and the wing trailing edge part, a first hydraulic unit is provided between the wing leading edge support rod connecting member 110 and the wing middle wing element support connecting member 210, wherein the first hydraulic unit comprises a second spherical hinged support 59, a third spherical hinged support 60, a second hinged support 61, a third hinged support 62, a first hydraulic assembly, and a second hydraulic assembly. Specifically, the second spherical hinged support 59 and the third spherical hinged support 60 are further provided on the side surface of the wing leading edge support rod connecting member 110 facing the wing middle wing element support connecting member 210, and the second hinged support 61 and the third hinged support 62 are correspondingly provided on the side surface of the wing middle wing element support connecting member 210 facing the wing leading edge support rod connecting member 110; wherein the second spherical hinged support 59 and the third spherical hinged support 60 are respectively located at two sides of the first spherical hinged support 26, and the second hinged support 61 and the third hinged support 62 are respectively located at two sides of the first hinged support 27 and are respectively arranged corresponding to the second spherical hinged support 59 and the third spherical hinged support 60; and wherein the first hydraulic assembly is provided between the second spherical hinged support 59 and the second hinged support 61, and the second hydraulic assembly is provided between the third spherical hinged support 60 and the third hinged support 62, wherein the first hydraulic assembly comprises a first hydraulic cylinder 63 and a first hydraulic push rod 64 connected to the first hydraulic cylinder 63, and the second hydraulic assembly comprises a second hydraulic cylinder 65 and a second hydraulic push rod 66 connected to the second hydraulic cylinder 65.

The control of the first hydraulic unit herein is as follows: the first hydraulic cylinder 63 and the first hydraulic push rod 64 cooperate with each other, and the second hydraulic cylinder 65 and the second hydraulic push rod 66 cooperate with each other; here, the elongation amount of the first hydraulic push rod 64 relative to the first hydraulic cylinder 63 is independent from the elongation amount of the second hydraulic push rod 66 relative to the second hydraulic cylinder 65. In this way, in the plane where the wing element structure is located, the second wing element support rod 16 and the fifth wing element support rod 19 can be controlled to move to any position relative to the first wing element support rod 15 and the fourth wing element support rod 18. Here, the movement of the second wing element support rod 16 and the fifth wing element support rod 19 formed under the control of the second hydraulic cylinder 65 and the second hydraulic push rod 66 is superposition of planar basic movement (translation on the plane and rotation on the plane), and thus can serve as a driving source of the first airfoil control unit 500.

Hereinafter, the movement control of the first airfoil control unit 500 located at the front of the wing element is described specifically:
in the actual movement of the wing element structure, under the control of the first hydraulic unit, if the relative position between the wing leading edge support rod 100, the second wing element support rod 16 and the fifth wing element support rod 19 changes, no matter swinging in a horizontal plane, or swinging in a vertical plane, or combined movement in the horizontal and vertical planes, the first sliding rod 25 will move relative to the first sliding ring 24. Further, as the airfoil control structure and the wing element outer frame have a linkage relationship, by the first sliding rod base hinged support 31, the second sliding rod base hinged support 32, the third sliding rod base hinged support 33, the fourth sliding rod base hinged support 34, the first sliding ring hinged support 39, the second sliding ring hinged support 40, the third sliding ring hinged support 41, and the fourth sliding ring hinged support 42, which are fixedly connected to the first sliding ring 24 and the first sliding rod 25, the relative movement between the first sliding rod 25 and the first sliding ring 24 is transferred to the first rod 43, the second rod 44, the third rod 47, the fourth rod 48, the fifth rod 51, the sixth rod 52, the seventh rod 55, and the eighth rod 56; wherein a linkage relationship is generated between the first rod 43 and the second rod 44 by the second hinged support 46, a linkage relationship is generated between the third rod 47 and the fourth rod 48 by the fourth hinged support 50, a linkage relationship is generated between the fifth rod 51 and the sixth rod 52 by the sixth hinged support 54, and a linkage relationship is generated between the seventh rod 55 and the eighth rod 56 by the eighth hinged support 58. In addition, the relative movement between the first sliding ring 24 and the first sliding rod 25 is transferred to the first hinged support 45, the third hinged support 49, the fifth hinged support 53 and the seventh hinged support 57, and thus the relative movement between the first sliding ring 24 and the first sliding rod 25 is transferred to the first wing element edge member 2, the second wing element edge member 4, the seventh wing element edge member 12 and the eighth wing element edge member 14 which can achieve passive deformation. In this way, the first wing element edge member 2, the second wing element edge member 4, the seventh wing element edge member 12 and the eighth wing element edge member 14 which can achieve passive deformation can follow the relative movement between the first sliding ring 24 and the first sliding rod 25.

Further, along with the movement of the first wing element edge member 2, the second wing element edge member 4, the seventh wing element edge member 12 and the eighth wing element edge member 14, the first flexible connecting member 301 and the fourth flexible connecting member 1301 each forming a flexible connection between adjacent wing element edge members can also generate telescopic movement. One end of the first sliding cover plate 302 is fixedly connected to the first wing element edge member 2, and the other end (a movement end) is slidably connected to the second wing element edge member 4, and along with the relative movement between the first wing element edge member 2 and the second wing element edge member 4, the movement end of the first sliding cover plate 302 is always closely attached to the second wing element edge member 4; and one end of the fourth sliding cover plate 1302 is fixed to the eighth wing element edge member 14, and the other end (a movement end) is slidably connected to the seventh wing element edge member 12, and along with the relative movement between the eighth wing element edge member 14 and the seventh wing element edge member 12, the movement end of the fourth sliding cover plate 1302 is always closely attached to the seventh wing element edge member 12.

It should be noted that the second airfoil control unit 600 has the same structure as the first airfoil control unit 500; the second hydraulic unit is provided between the wing middle wing element support connecting member 210 and the wing trailing edge wing element support connecting member 310, and the second hydraulic unit has the same structure and function as the first hydraulic unit, they will not be elaborated more herein in the present disclosure.

Of course, as for the motion control of the second airfoil control unit 600, reference is made to the first airfoil control unit 500, which will not be repeated herein.

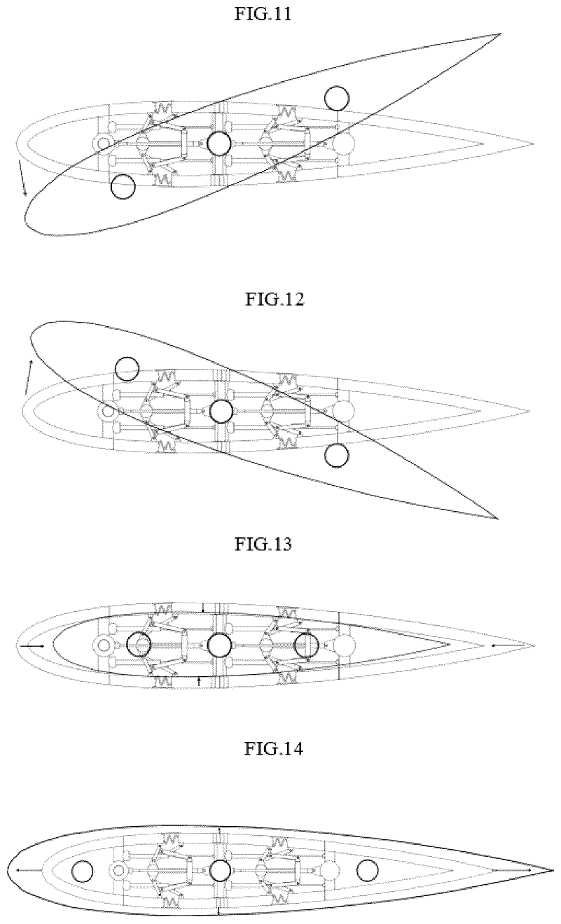

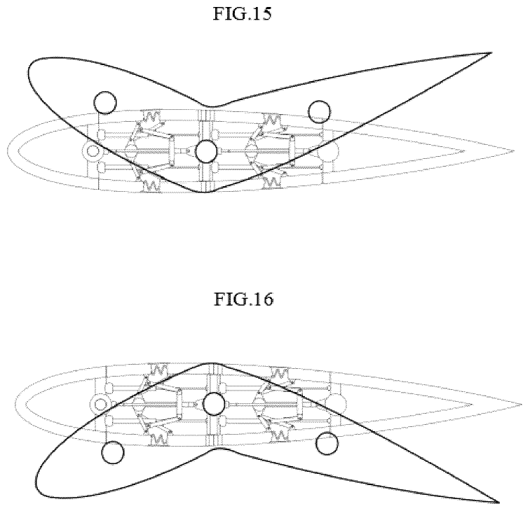

By the wing element structure of the present embodiment, on the basis of the adjustment of the airfoil control units, the movement of the wing element structure can be realized, for example, by means of the movement of the wing structure or the change of relative positions, i.e. various airfoil deformations, thereby realizing the basic action of plane airfoil transformation. FIGS. 11 and 12 are schematic diagrams of change of airfoil angle of attack, thereby achieving a pitch down action as shown in FIG. 11 and a pitch up action as shown in FIG. 12. Of course, as shown in FIGS. 13 and 14, the embodiments of the present disclosure can also realize change in the wing element structure, i.e. telescoping deformation of the airfoil, for example, by the relative movement between the first sliding ring connecting rod 23 and the first sliding rod 25, an airfoil reduction action as shown in FIG. 13 is achieved; or by the two airfoil control units driving the wing element structure to increase, an airfoil increase action as shown in FIG. 14 is achieved. The embodiments of the present disclosure can also achieve a bending action of the airfoil plane. FIGS. 15 and 16 are schematic diagrams of bending actions of an airfoil plane of the wing element structure, in which FIG. 15 shows a schematic diagram of upward bending of the wing element structure, and FIG. 16 shows a schematic diagram of downward bending of the wing element structure.

Of course, the airfoil change actions can realize complex actions of plane airfoil transformation by combination: such transformation uses permutation and combination of basic actions of the plane airfoil, belongs to a combined motion, and realizes complex transformation of the airfoil, which will not be elaborated more herein in the present disclosure.

By the wing element structure of the present embodiment, multiple airfoil deformations can be achieved on the basis of the adjustment of the airfoil control units. Complex actions of airfoil transformations can also be achieved, and such complex transformations are based on change of angle of attack of basic actions of plane airfoil transformation, similar tensile compression deformation and planar bending, and here only warping movement of the side surface of the wing element is supplemented.

A second embodiment of the present disclosure provides a wing element structure capable of being deformed in multiple dimensions. A plurality of the wing element structures are sequentially sleeved on the wing leading edge support rod 100 to form the wing structure; and the structures of wing element structure and the wing structure herein are basically the same as those in the first embodiment, and will not be repeated in the present embodiment. As shown in FIG. 17, the only difference from the first embodiment lies in the movement connection structures between the wing element leading edge unit, the wing element middle unit, and the wing element trailing edge unit in the wing element structure.

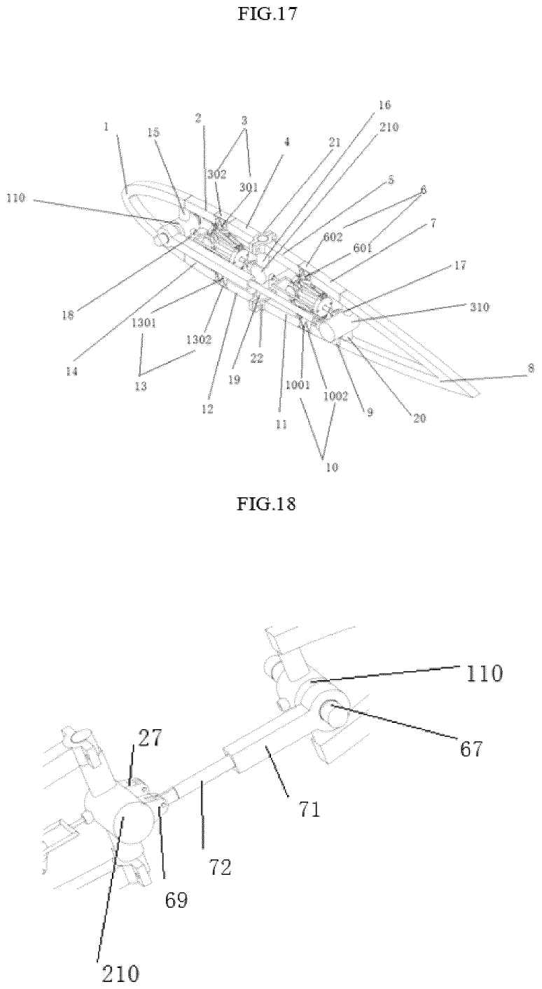

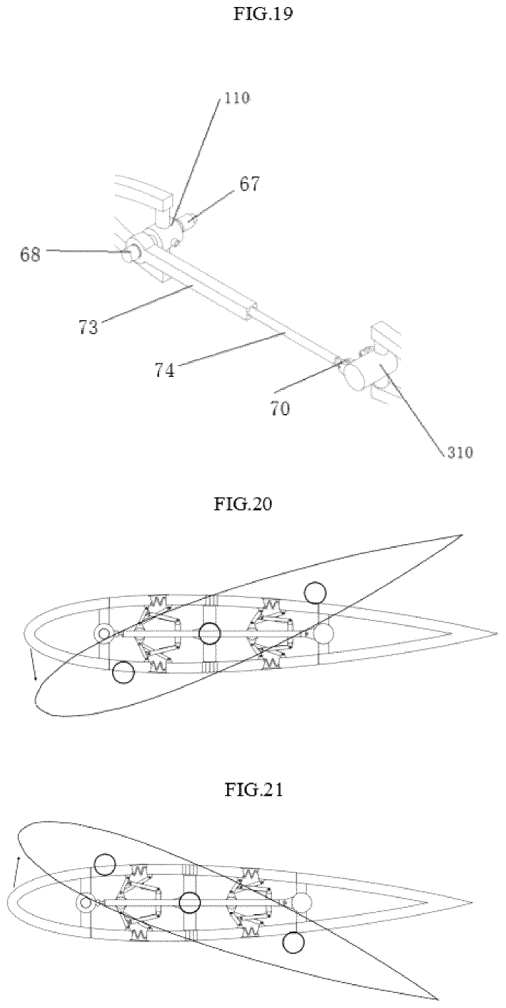

Furthermore, as shown in FIGS. 18 and 19, a third hydraulic unit is provided between the wing leading edge support rod connecting member 110 and the wing middle wing element support connecting member 210, and a fourth hydraulic unit is provided between the wing leading edge support rod connecting member 110 and the wing trailing edge wing element support connecting member 310; wherein the third hydraulic unit comprises a first rotating motor 67, a fourth hinged support 69 and a third hydraulic assembly, and the fourth hydraulic unit comprises a second rotating motor 68, a fifth hinged support 70 and a fourth hydraulic assembly. Specifically, at two sides of the wing leading edge support rod connecting member 110, the first rotating motor 67 and the second rotating motor 68 are symmetrically arranged on the wing leading edge support rod 100 connected to the wing leading edge support rod connecting member 110; the fourth hinged support 69 is correspondingly provided on the side surface of the wing middle wing element support connecting member 210 facing the wing leading edge support rod connecting member 110; and the fifth hinged support 70 is correspondingly provided on the side surface of the wing trailing edge wing element support connecting member 310 facing the wing leading edge support rod connecting member 110. The fourth hinged support 69 and the fifth hinged support 70 are respectively located at two sides of the first hinged support 27, and are respectively arranged corresponding to the first rotating motor 67 and the second rotating motor 68; wherein the third hydraulic assembly is provided between the first rotating motor 67 and the fourth hinged support 69, and the fourth hydraulic assembly is provided between the second rotating motor 68 and the fifth hinged support 70; wherein the third hydraulic assembly comprises a third hydraulic cylinder 71 and a third hydraulic push rod 72 connected to the third hydraulic cylinder 71, and the fourth hydraulic assembly comprises a fourth hydraulic cylinder 73 and a fourth hydraulic push rod 74 connected to the fourth hydraulic cylinder 73; the third hydraulic cylinder 71 is sleeved on a stator of the first rotating motor 67, and the fourth hydraulic cylinder 73 is sleeved on a stator of the second rotating motor 68.

The control of the third hydraulic unit herein is as follows:
the third hydraulic cylinder 71 and the third hydraulic push rod 72 cooperate with each other, and the third hydraulic cylinder 71 is sleeved on the stator of the first rotating motor 67, and thus the third hydraulic cylinder 71 can rotate around the wing leading edge support rod 100, the third hydraulic push rod 72 can stretch and retract in a reciprocating manner under a hydraulic pressure, and the third hydraulic push rod 72 is hinged to the wing middle wing element support connecting member 210. In this way, the translation and rotation of the third hydraulic unit in the plane relative to the wing leading edge support rod 100 can be transferred to the wing middle wing element support connecting member 210.

The control of the fourth hydraulic unit herein is as follows:
the fourth hydraulic cylinder 73 and the fourth hydraulic push rod 74 cooperate with each other, and the fourth hydraulic cylinder 73 is sleeved on the stator of the second rotating motor 68, and thus the fourth hydraulic cylinder 73 can rotate around the wing leading edge support rod 100, the fourth hydraulic push rod 74 can stretch and retract in a reciprocating manner under a hydraulic pressure, and the fourth hydraulic push rod 74 is hinged to the wing trailing edge wing element support connecting member 310. In this way, the translation and rotation of the fourth hydraulic unit in the plane relative to the wing leading edge support rod 100 can be transferred to the wing trailing edge wing element support connecting member 310.

Hereinafter, the movement control of the first airfoil control unit 500 located at the front of the wing element is described specifically:

in the actual movement of the wing element structure, taking the control of the third hydraulic unit as an example, under the control of the third hydraulic unit, if the relative position between the wing leading edge support rod 100 and the wing middle wing element support connecting member 210 changes, no matter swinging in a horizontal plane, or swinging in a vertical plane, or combined movement in the horizontal and vertical planes, the first sliding rod 25 will move relative to the first sliding ring 24. Further, as the airfoil control structure and the wing element outer frame have a linkage relationship, by the first sliding rod base hinged support 31, the second sliding rod base hinged support 32, the third sliding rod base hinged support 33, the fourth sliding rod base hinged support 34, the first sliding ring hinged support 39, the second sliding ring hinged support 40, the third sliding ring hinged support 41, and the fourth sliding ring hinged support 42, which are fixedly connected to the first sliding ring 24 and the first sliding rod 25, the relative movement between the first sliding rod 25 and the first sliding ring 24 is transferred to the first rod 43, the second rod 44, the third rod 47, the fourth rod 48, the fifth rod 51, the sixth rod 52, the seventh rod 55, and the eighth rod 56; wherein a linkage relationship is generated between the first rod 43 and the second rod 44 by the second hinged support 46, a linkage relationship is generated between the third rod 47 and the fourth rod 48 by the fourth hinged support 50, a linkage relationship is generated between the fifth rod 51 and the sixth rod 52 by the sixth hinged support 54, and a linkage relationship is generated between the seventh rod 55 and the eighth rod 56 by the eighth hinged support 58. In addition, the relative movement between the first sliding ring 24 and the first sliding rod 25 is transferred to the first hinged support 45, the third hinged support 49, the fifth hinged support 53 and the seventh hinged support 57, and thus the relative movement between the first sliding ring 24 and the first sliding rod 25 is transferred to the first wing element edge member 2, the second wing element edge member 4, the seventh wing element edge member 12 and the eighth wing element edge member 14 which can achieve passive deformation. In this way, the first wing element edge member 2, the second wing element edge member 4, the seventh wing element edge member 12 and the eighth wing element edge member 14 which can achieve passive deformation can follow the relative movement between the first sliding ring 24 and the first sliding rod 25.

Further, along with the movement of the first wing element edge member 2, the second wing element edge member 4, the seventh wing element edge member 12 and the eighth wing element edge member 14, the first flexible sealing connecting member 301 and the fourth flexible sealing connecting member 1301 each forming a flexible connection between adjacent wing element edge members can also generate telescopic movement. One end of the first sliding cover plate 302 is fixedly connected to the first wing element edge member 2, and the other end (a movement end) is slidably connected to the second wing element edge member 4, and along with the relative movement between the first wing element edge member 2 and the second wing element edge member 4, the movement end of the first sliding cover plate 302 is always closely attached to the second wing element edge member 4; and one end of the fourth sliding cover plate 1302 is fixed to the eighth wing element edge member 14, and the other end (a movement end) is slidably connected to the seventh wing element edge member 12, and along with the relative movement between the eighth wing element edge member 14 and the seventh wing element edge member 12, the movement end of the fourth sliding cover plate 1302 is always closely attached to the seventh wing element edge member 12.

Of course, as for the motion control of the second airfoil control unit 600, reference is made to the first airfoil control unit 500, which will not be repeated herein.

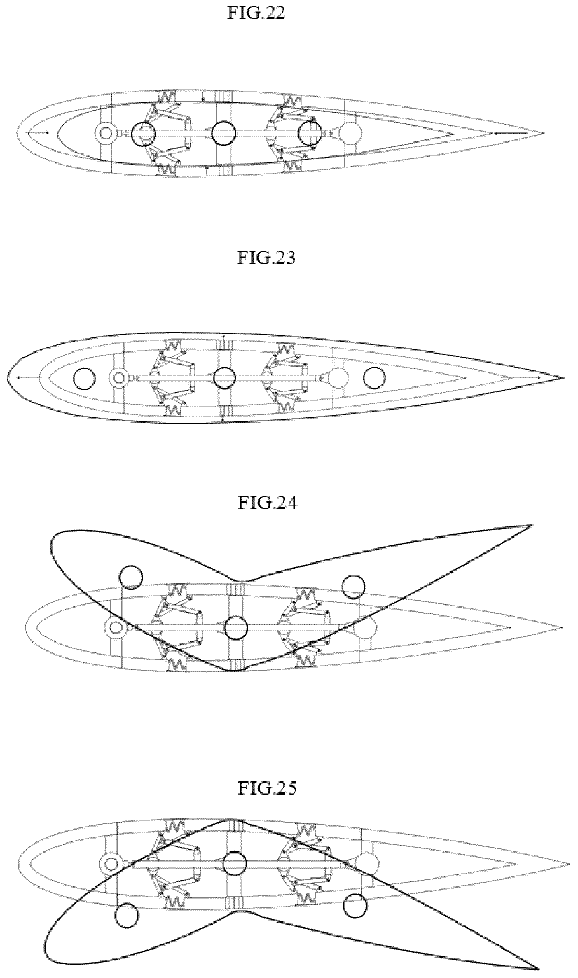

By the wing element structure of the present embodiment, on the basis of the adjustment of the airfoil control units, the movement of the wing element structure can be realized, for example, by means of the movement of the wing structure or the change of relative positions, i.e. various airfoil deformations, thereby realizing the basic action of plane airfoil transformation. FIGS. 20 and 21 are schematic diagrams of change of airfoil angle of attack, thereby achieving a pitch down action as shown in FIG. 20 and a pitch up action as shown in FIG. 21. Of course, as shown in FIGS. 22 and 23, the embodiments of the present disclosure can also realize change in the wing element structure, i.e. telescoping deformation of the airfoil, for example, by the relative movement between the first sliding ring connecting rod 23 and the first sliding rod 25, an airfoil reduction action as shown in FIG. 22 is achieved; or by the two airfoil control units driving the wing element structure to increase, an airfoil increase action as shown in FIG. 23 is achieved. The embodiments of the present disclosure can also achieve a bending action of the airfoil plane. FIGS. 24 and 25 are schematic diagrams of bending actions of an airfoil plane of the wing element structure, in which FIG. 24 shows a schematic diagram of upward bending of the wing element structure, and FIG. 25 shows a schematic diagram of downward bending of the wing element structure.

Of course, the airfoil change actions can realize complex actions of plane airfoil transformation by combination: such transformation uses permutation and combination of basic actions of the plane airfoil, belongs to a combined motion, and realizes complex transformation of the airfoil, which will not be elaborated more herein in the present disclosure.

By the wing element structure of the present embodiment, multiple airfoil deformations can be achieved on the basis of the adjustment of the airfoil control units. Complex actions of airfoil transformations can also be achieved, and such complex transformations are based on change of angle of attack of basic actions of plane airfoil transformation, similar tensile compression deformation and planar bending,

Furthermore, while exemplary embodiments have been described herein, the scope thereof comprises any and all embodiments having equivalent elements, modifications, omissions, combinations (e.g., solutions in which various embodiments overlap), adaptations or alterations based on the present disclosure. The elements in the claims are to be construed broadly based on the language used in the claims, and are not limited to the examples described in the present description or during the implementation of the present application, and examples thereof are to be construed as non-exclusive. Therefore, the present description and examples are intended to be considered as exemplary only, and the real scope and spirit are indicated by the full scope of the following claims and equivalents thereof.

The description above is intended to be illustrative rather than restrictive. For example, the examples above (or one or more solutions thereof) may be used in combination with one another. Other embodiments can be used, for example, by a person of ordinary skill in the art when reading the description above. Additionally, in the Detailed Description of the Embodiments above, various features may be grouped together to simply the present disclosure. This is not to be construed as an intention that disclosed features not claimed are essential to any one claim. Rather, the subject matter of the present disclosure may be less than all features of particular embodiments disclosed. Thus, the following claims are hereby incorporated into the Detailed Description of the Embodiments as examples or embodiments, wherein each claim independently serves as a separate embodiment, and it is considered that these embodiments may be combined with one another in various permutations or arrangements.

The scope of the present disclosure should be determined with reference to the full scope of the appended claims along with equivalent forms entitled by these claims. The embodiments above are only exemplary embodiments of the present disclosure and are not intended to limit the present disclosure, and the scope of protection of the present disclosure is defined by the claims. A person skilled in the art could make various modifications or equivalent replacements to the present disclosure within the spirit and scope of protection of the present disclosure, and such modifications or equivalent replacements shall also belong to the scope of protection of the present disclosure.

What is claimed is:

1. Awing element structure for an aircraft, comprising a plurality of wing element units, wherein adjacent wing element units are connected by airfoil control units, hydraulic units and wing element outer edge connecting members, each of the wing element units comprises a plurality of wing element edge members connected to one another and a wing support rod connecting member, and the wing support rod connecting member located in a wing leading edge in the wing element unit is connected to a support rod structure on an aircraft main body.

2. The wing element structure according to claim 1, wherein the wing element unit further comprises wing connecting members, and the wing support rod connecting member connected to the support rod structure is connected to the wing connecting members by the hydraulic units, or a plurality of the wing connecting members are connected by the hydraulic units.

3. The wing element structure according to claim 2, wherein the plurality of wing element units comprise a wing element leading edge unit and a wing element trailing edge unit, and at least one wing element middle unit is provided between the wing element leading edge unit and the wing element trailing edge unit.

4. The wing element structure according to claim 3, wherein the wing support rod connecting member in the wing element leading edge unit is connected to the support rod structure, the wing support rod connecting member in the wing element leading edge unit is connected to a wing connecting member in the wing element middle unit by a first hydraulic unit, and the connecting member in the wing element middle unit is connected to a wing connecting member in the wing element trailing edge unit by a second hydraulic unit.

5. The wing element structure according to claim 3, wherein the wing support rod connecting member in the wing element leading edge unit is connected to the support rod structure, the wing support rod connecting member in the wing element leading edge unit is connected to the wing connecting member in the wing element middle unit by a third hydraulic unit, and the wing support rod connecting member in the wing element leading edge unit is connected to the wing connecting member in the wing element trailing edge unit by a fourth hydraulic unit.

6. The wing element structure according to claim 3, wherein the wing element leading edge unit comprises a wing element leading edge arc-shaped member, a first wing element edge member, an eighth wing element edge member, and a wing leading edge support rod connecting member; a first end of the first wing element edge member and a first end of the eighth wing element edge member are respectively connected to a first end and a second end of the wing element leading edge arc-shaped member; a second end of the first wing element edge element and a second end of the eighth wing element edge member are respectively connected to a first rolling bearing and a sixth rolling bearing; the first rolling bearing and the sixth rolling bearing are connected by a first wing element unit support member, and the first wing element unit support member passes through and is connected to the wing leading edge support rod connecting member.

7. The wing element structure according to claim 3, wherein the wing element trailing edge unit comprises a wing element trailing edge wedge-shaped member, a fourth wing element edge member, a fifth wing element edge member and a wing trailing edge wing element support connecting member; a first end of the fourth wing element edge member and a first end of the fifth wing element edge member are respectively connected to a first end and a second end of the wing element trailing edge wedge-shaped member; a second end of the fourth wing element edge member and a second end of the fifth wing element edge member are respectively connected to a third rolling bearing and a fourth rolling bearing; the third rolling bearing and the fourth rolling bearing are connected by a third wing element unit support member, and the third wing element unit support member passes through and is connected to the wing trailing edge wing element support connecting member.

8. The wing element structure according to claim 3, wherein the wing element middle unit comprises a second wing element edge member, a third wing element edge member, a sixth wing element edge member, a seventh wing element edge member, and a wing middle wing element support connecting member; a first end of the second wing element edge member and a first end of the third wing element edge member are connected by a second rolling bearing, and a first end of the sixth wing element edge member and a first end of the seventh wing element edge member are connected by a fifth rolling bearing; the second rolling bearing and the fifth rolling bearing are connected by a second wing element unit support member, and the second wing element unit support member passes through and is connected to the wing middle wing element support connecting member.

9. The wing element structure according to claim 1, wherein the wing element edge members of adjacent wing element units are connected by the wing element outer edge connecting members, each wing element outer edge connecting member comprise a flexible connecting member and a sliding cover plate; the flexible connecting member can telescopically connect adjacent wing element edge members, one end of the sliding cover plate is fixedly connected to an end of one wing element edge member, and the other end of the sliding cover plate is slidably connected to an end of the other adjacent wing element edge member.

10. The wing element structure according to claim 9, wherein each of the airfoil control units comprises a sliding ring connecting rod, a sliding ring and a sliding rod, wherein one end of the sliding ring connecting rod is connected to a side surface of the wing support rod connecting member or wing connecting member of a first wing unit of a first wing element unit, and the other end of the sliding ring connecting rod is connected to the sliding ring; the sliding rod is provided on a side surface of the wing connecting member of a second wing element unit adjacent to the first wing element unit and extends towards the direction of the wing support rod connecting member or wing connecting member of the first wing unit, and the sliding ring is sleeved on the sliding rod and can slide along the sliding rod in a reciprocating manner.

11. The wing element structure according to claim 10, wherein a sliding rod base is provided at the top of the sliding rod, two sliding rod base hinged supports are respectively provided on a first side and a second side, opposite each other, of the sliding rod base, and each sliding rod base hinged support is connected to a corresponding sliding ring hinged support on the sliding ring by a lever group.

12. The wing element structure according to claim 10, wherein on a first side or a second side of the sliding rod base, the lever group comprises a front rod and a rear rod connected to each other, a first end of the front rod is connected to a corresponding sliding rod base hinged support, a second end of the front rod is connected to a corresponding wing element edge member by a hinged support, a middle part of the front rod is connected to a first end of the rear rod by another hinged support, and a second end of the rear rod is connected to a corresponding sliding ring hinged support on the sliding ring.

13. A wing structure, comprising the wing element structure according to claim 12.

14. An aircraft, using the wing structure according to claim 13.
